(19) United States
(12) Patent Application Publication
(10) Pub. No.: US 2018/0031862 A1
(43) Pub. Date: Feb. 1, 2018

(54) GLASSES

(71) Applicant: Shenzhen Huiming Optical Co., Ltd., Shenzhen (CN)

(72) Inventor: ZHAOJIAO LI, Shenzhen (CN)

(21) Appl. No.: 15/494,529

(22) Filed: Apr. 23, 2017

(30) Foreign Application Priority Data
Aug. 1, 2016 (CN) 201620825065.4

(51) Int. Cl. G02C 5/12

(52) U.S. Cl. CPC G02C 5/126; G02C 2200/08; G02C 2200/32

(57) ABSTRACT

A pair of glasses includes frame including a first frame including a supporting portion and a second frame including a supporting portion, a pan of glasses legs mounted to the frame, and at least one pair of nose rest members. Each of the supporting portions defines a groove extending through the supporting portion, and each of the nose rest members is partly received in a corresponding groove. The nose rest members can be pulled out of the grooves by a hand of a user.

### BACKGROUND

### 1. Technical Field

The present disclosure generally relates to a pair of glasses.

### 2. Description of Related Art

Traditionally a pair of glasses includes a frame, a pair of glasses legs mounted to the frame, and a pair of nose rest members mounted to the frame by a pair of screws. After a long time, a user having the traditional glasses needs to go to a special glasses shop to replace the nose rest members, resulting in inconvenience to use.

### SUMMARY

The disclosure relates to a pair of glasses.

A pair of glasses includes a frame including a first frame including a supporting portion and a second frame including a supporting portion, a pair of glasses legs mounted to the frame, and at least one pair of nose rest members. Each of the supporting portions defines a groove extending through the supporting portion, and each of the nose rest members is partly received in a corresponding groove. Wherein the nose rest members can be pulled out of the grooves by a hand of a user.

Wherein each of he nose rest members includes a contacting portion for supporting the glasses and contacting with a nose of the user, a fixing portion extending through the groove to mounted the nose rest member to the frame, and a connecting portion located between the contacting portion and the fixing portion and fitly received in the groove.

Wherein a maximum diameter of the groove is generally equal to a maximum diameter of the connecting portion, and a minimum diameter of the fixing portion is greater than the maximum diameter of the groove.

Wherein each of the supporting portions defines a recess, and each of the contacting portions is partly received in a corresponding recess to locate the contacting portion.

Wherein the glasses include a plurality pairs of different nose rest members each having different features, and the different features comprises material, color, size.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a perspective view of a pair of glasses in accordance with the present invention;

FIG. 2 is an exploded perspective view of a first frame and a nose rest member of FIG. 1; and

FIG. 3 is an enlarged perspective view of nose rest member of FIG. 2, viewed from another aspect.

### DETAILED DESCRIPTION

The disclosure is illustrated by way of example and not by way of limitation in the figures of the accompanying drawings, in which like reference numerals indicate similar elements. The embodiments described in accordance with the drawings are only examples, and thus the claimed invention is not limited thereto.

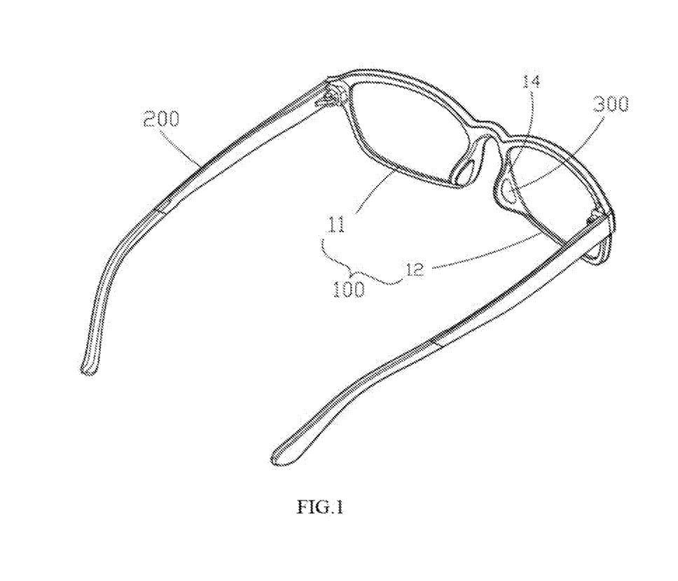

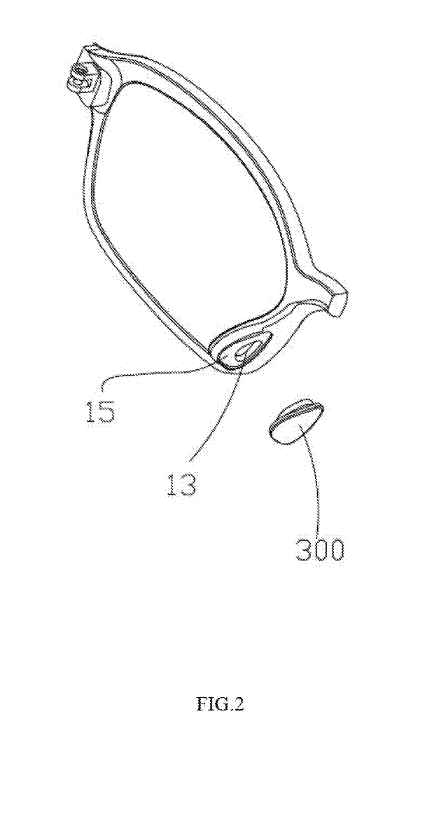

Referring to FIG. 1 and FIG. 2, a pair of glasses includes a frame 100 and a pair of glasses legs 200 mounted to the frame 100, and at least one pair of nose rest members 300 mounted to the frame 100.

The frame 100 includes a first frame 11 defining a supporting portion 14 and a second frame 12 defining a supporting portion 14. Each of the supporting portions 14 includes a recess 15 and a groove 13 extending through the supporting portion 14.

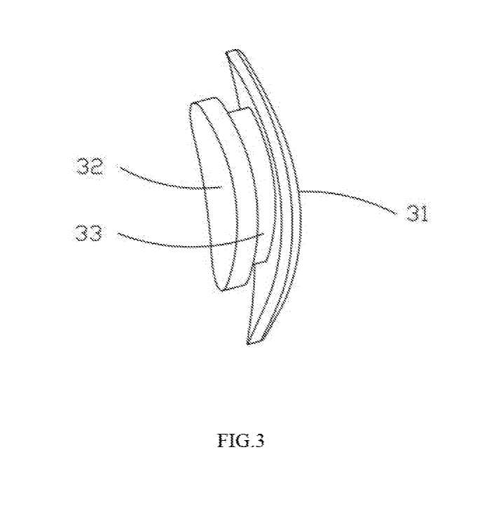

Referring also to FIG. 3, each of the nose rest members 300 includes a contacting portion 31 for supporting the glasses and contacting with a nose of a user, a fixing portion 32 extending through the groove 13 to mounted the nose rest member 300 to the frame 100, and a connecting portion 33 located between the contacting portion 31 and a fixing portion 32 and fitly received in the groove 13.

A maximum diameter of the groove 13 is generally equal to a maximum diameter of the connecting portion 33, and a minimum diameter of the fixing portion 32 is greater than the maximum diameter of the groove 13 to prevent the nose rest member 300 from accidently disengaging from the frame 100.

In one embodiment, the glasses include a plurality pairs of different nose rest members 300 each having different features, and the different features include material, color, size.

In another embodiment, the features of the fixing portions 32 and the connecting portions 33 are the same, the features of the contacting portion 31 are different.

Referring to FIG. 1 to FIG. 3, in assemble, the fixing portion 32 extends through a corresponding groove 13 by a hand of the user applying a force on the contacting portion 31. In this state, each of the contacting portions 33 is partly received in a corresponding recess 15 to locate the contacting portion 33 and prevent the contacting portion 33 from moving; in disassemble, the fixing portion 32 can be pulled out of the corresponding groove 13 by the hand of the user applying a force on the contacting portion 31. That is to say, the user can freely install or remove the nose rest members 300 by the hand, thereby improving the convenience of installation and removal.

In addition, the glasses include a plurality pairs of different nose rest members 300 each having different contacting portions 31 and different color, so that the user can replaces different nose rest members 300 according to the user's requirement.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A pair of glasses, comprising:
a frame comprising a first frame comprising a supporting portion and a second frame comprising a supporting portion, wherein each of the supporting portions defines a groove extending through the supporting portion;
a pair of glasses legs mounted to the frame; and
at least one pair of nose rest members partly received in a corresponding groove;
wherein the nose rest members can be pulled out of the grooves by a hand of a user.

2. The glasses of claim I wherein each of the nose rest members comprising:
a contacting portion for supporting the glasses and contacting with a nose of the user;
a fixing portion extending through the groove to mounted the nose rest member to the frame; and
a connecting portion located between the contacting portion and the fixing portion and fitly received in the groove.

3. The glasses of claim 2, wherein a maximum diameter of the groove is generally equal to a maximum diameter of the connecting portion, and a minimum diameter of the fixing portion is greater than the maximum diameter of the groove.

4. The glasses of claim 2, wherein each of the supporting portions defines a recess, and each of the contacting portions is partly received in a corresponding recess to locate the contacting portion.

5. The glasses of claim 2, wherein the grasses comprise a plurality pairs of different nose rest members each having different features, and the different features comprises material, color, size.
